(19) United States
(12) Patent Application Publication
(10) Pub. No.: US 2021/0354278 A1
(43) Pub. Date: Nov. 18, 2021

(54) IMPACT DEVICE

(71) Applicant: BASSO INDUSTRY CORP., Taichung (TW)

(72) Inventors: Chun-Chi LAI, Taichung (TW); Chun-Chiang CHEN, Taichung (TW); Liang-Chi HUNG, Taichung (TW); Sheng-Man WANG, Taichung (TW)

(73) Assignee: BASSO INDUSTRY CORP., Taichung (TW)

(21) Appl. No.: 17/321,594

(22) Filed: May 17, 2021

(30) Foreign Application Priority Data
May 18, 2020 (TW) 109116367

(51) Int. Cl. B25C 1/06; B25D 11/06

(52) U.S. Cl. CPC B25C 1/06; B25D 11/068

(57) ABSTRACT

An impact device is adapted to be mounted to an electric nail gun that includes a flywheel, and includes a swing arm unit, a track unit and an impact unit. The swing arm unit is adapted to be pivoted toward or away from the flywheel. The track unit includes a guiding track movably connected to the swing arm unit. The impact unit is connected to the guiding track, and is movable relative to the guiding track in a striking direction and a return direction that are opposite to each other. The guiding track is movable resiliently relative to the swing arm unit between a front position, where the impact unit is adapted to contact the flywheel, and a rear position, where the impact unit is adapted to be spaced apart from the flywheel.

### CROSS-REFERENCE TO RELATED APPLICATION

This application claims priority of Taiwanese Patent Application No. 109116367, filed on May 18, 2020.

### FIELD

The disclosure relates to an electric nail gun, and more particularly to an impact device for use with an electric nail gun.

### BACKGROUND

Referring to FIGS. 1 and 2, a conventional electric nail gun 1 disclosed in Taiwanese Utility Model Patent No. M482482 includes a machine frame 11, a flywheel 12, a motor unit 13, a swing arm 14, an impact member 15 and two retrieving units 16. The flywheel 12 is pivotally connected to the machine frame 11. The motor unit 13 drives the flywheel 12 to rotate with electric power. The swing arm 14 is pivotally connected to the machine frame 11 so as to be pivoted toward or away from the flywheel 12. The impact member 15 is movably mounted to the swing arm 14, and is movable relative to the swing arm 14 between a pre-firing position and a firing position. The retrieving units 16 are connected between the swing arm 14 and the impact member 15 for biasing the impact member 15 towards the pre-firing position.

When the flywheel 12 starts to rotate until reaching a predetermined speed (or predetermined rotational energy), the swing arm 14 may be operated to move toward the flywheel 12 so as to bring the impact member 15 into contact with the flywheel 12. Once contacting with the flywheel 12, the impact member 15 is driven by rotational energy released by the flywheel 12 to move in a striking direction (X1) from the pre-firing position, toward a front end of the swing arm 14, to the firing position. After striking a nail, the impact member 15 is biased by the retrieving units 16 to move in a return direction (X2) from the firing position, toward a rear end of the swing arm 14, back to the pre-firing position.

Referring to FIGS. 1, 2 and 3, after the flywheel 12 reaches the predetermined speed, there are a few significant time periods to be observed: a first time period (t1), which starts when the impact member 15 is brought into contact with the flywheel 12, and which terminates when the impact member 15 becomes detached from the flywheel 12; a second time period (t2), which starts when the impact member 15 is driven by the flywheel 12 to start moving in the striking direction (X1) from the pre-firing position, and which terminates when the impact member 15 arrives at the firing position; a third time period (t3), which starts when the flywheel 12 reaches the predetermined speed and terminates when the flywheel 12 stops rotating; and a fourth time period (t4), which starts when the impact member 15 starts moving in the return direction (X2) from the firing position, and which terminates when the impact member 15 returns to the pre-firing position.

In order to ensure that the nail can reach a desired depth after a nail-striking action, the conventional electric nail gun 1 is designed in such manner that the first time period (t1) is longer than the second time period (t2), and the third time period (t3) is longer than or equal to the second time period (t2). However, for such conventional electric nail gun 1, a beginning portion of the fourth time period (t4) overlaps with an end portion of the first time period (t1) (i.e., after the impact member 15 has already started moving in the return direction (X2), there is a brief moment in which the swing arm 14 is still proximate to the flywheel 12 and still keeps the impact member 15 in contact with the flywheel 12). Therefore, in the case of the third time period (t3) being longer than the second time period (t2), the rotation of the flywheel 12 and the movement of the impact member 15 in the return direction (X2) will counteract each other. As such, if the rotational energy of the flywheel 12 is greater than the kinetic energy that drives the movement of the impact member 15 in the return direction (X2), the impact member 15 will be driven by the flywheel 12 to move in the striking direction (X1) again. Moreover, regardless of the third time period (t3) being longer than or equal to the second time period (t2), the rotational energy of the flywheel 12 is almost, if not completely, cancelled out by the kinetic energy of the impact member 15, and the flywheel 12 may even be driven to rotate in an opposite direction. In this case, if another nail-striking action is to be performed, the motor unit 13 is required to output significant amount of energy in order to drive the rotation of the flywheel to reach the predetermined speed again, which results in inefficient power consumption and potentially overheating of the motor unit 13. In addition, the flywheel 12 and the impact member 15 are subject to excessive wear and tear.

### SUMMARY

Therefore, the object of the disclosure is to provide an impact device for use with an electric nail gun that can alleviate at least one of the drawbacks of the prior art.

According to the disclosure, an impact device is adapted to be mounted to an electric nail gun. The electric nail gun includes a supporting frame, and a flywheel that is rotatably mounted to the supporting frame. The impact device includes a swing arm unit, a track unit and an impact unit.

The swing arm unit is adapted to be connected to the supporting frame, and is adapted to be pivotable relative to the supporting frame toward or away from the flywheel.

The track unit includes a guiding track that is movably connected to the swing arm unit.

The impact unit is adapted to be disposed between the flywheel and the guiding track, is movably connected to the guiding track, and is movable relative to the guiding track in a striking direction and a return direction that are opposite to each other.

The guiding track is movable resiliently relative to the swing arm unit between a front position, where the impact unit is adapted to contact the flywheel such that rotation of the flywheel drives the impact unit to move in the striking direction, and a rear position, where the impact unit is adapted to be spaced apart from the flywheel such that movement of the impact unit in the return direction is not affected by the flywheel.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a conventional electric nail gun disclosed in Taiwanese Utility Model Patent No. M482482;

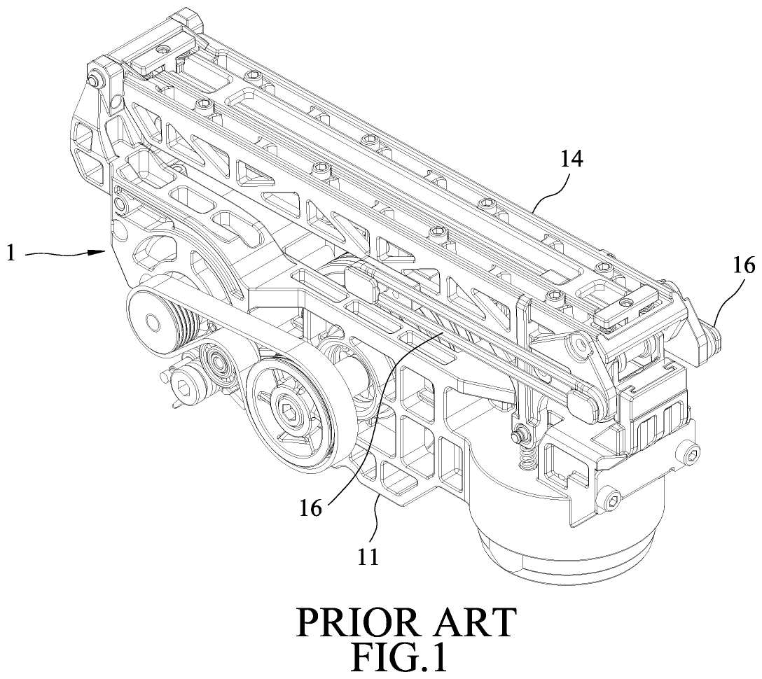

FIG. 2 is a sectional view of the conventional electric nail gun;

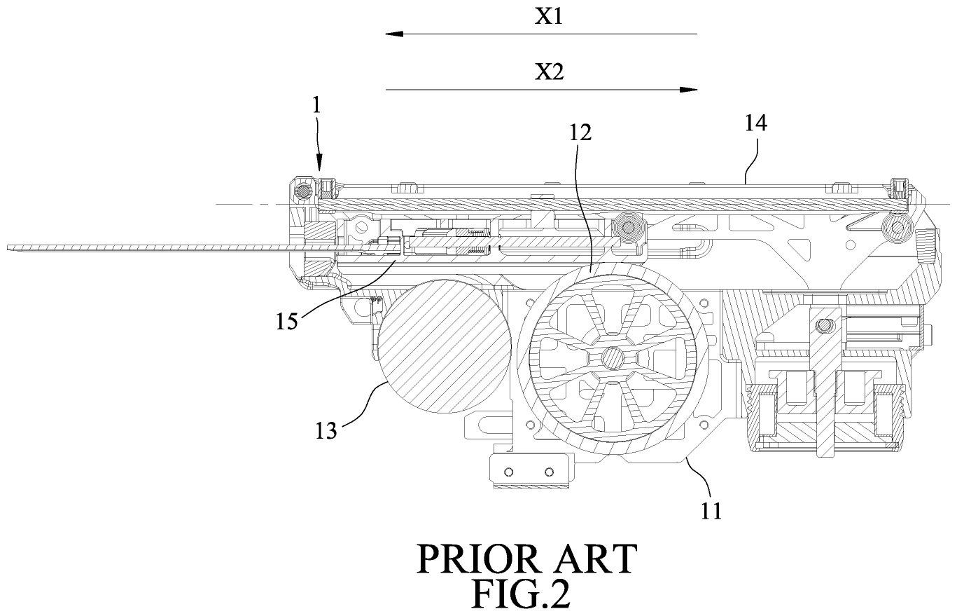

FIG. 3 is a schematic diagram, illustrating a plurality of time periods observed in an operation of the conventional electric nail gun;

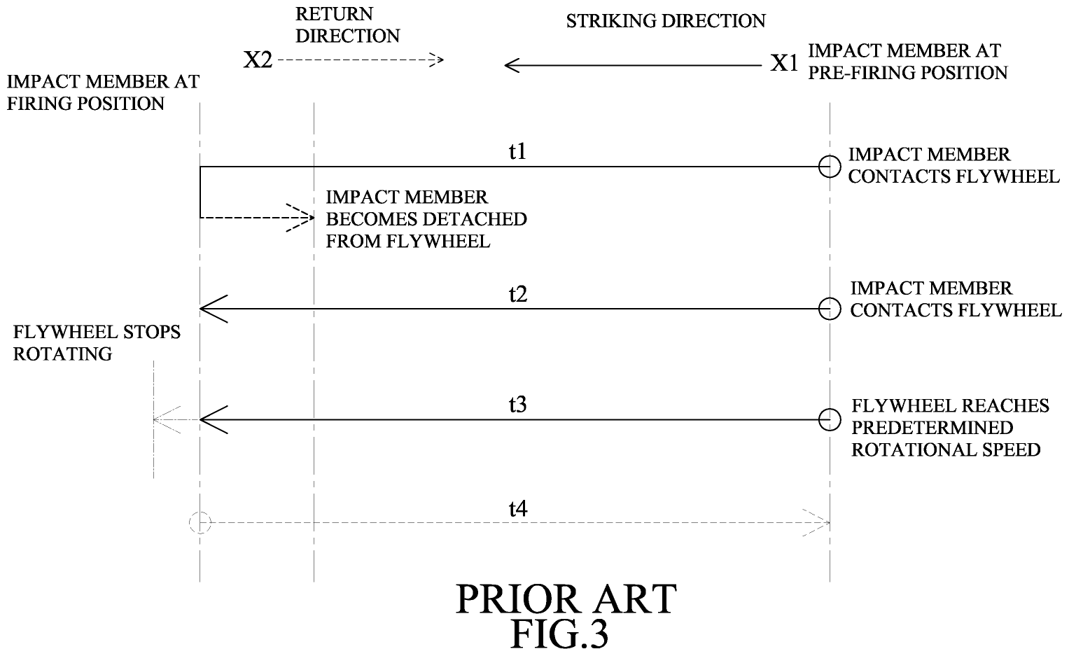

FIG. 4 is a side view, illustrating an embodiment of an impact device mounted to an electric nail gun according to the disclosure;

FIG. 5 is an exploded perspective view, illustrating a swing arm unit and a track unit of the embodiment;

FIG. 6 is a perspective view, illustrating the swing arm unit and the track unit of the embodiment;

FIG. 7 is a sectional view, illustrating the swing arm unit being distal from a flywheel of the electric nail gun, and an impact member of the embodiment at a pre-firing position;

FIG. 8 is a fragmentary side view, illustrating the swing arm unit being proximate to the flywheel, and the impact member contacting the flywheel;

FIG. 9 is a view similar to FIG. 8, illustrating the impact member moving in a striking direction to a firing position, and a guiding track of the track unit at a front position;

FIG. 10 is a view similar to FIG. 9, illustrating the impact member starting to move in a return direction opposite to the striking direction, and the guiding track at a rear position;

FIG. 11 is a view similar to FIG. 7, illustrating two rollers of the embodiment being partially received in two arc-shaped grooves of the track unit; and

FIG. 12 is another schematic diagram, illustrating a plurality of time periods observed in an operation of the electric nail gun mounted with the present embodiment.

### DETAILED DESCRIPTION

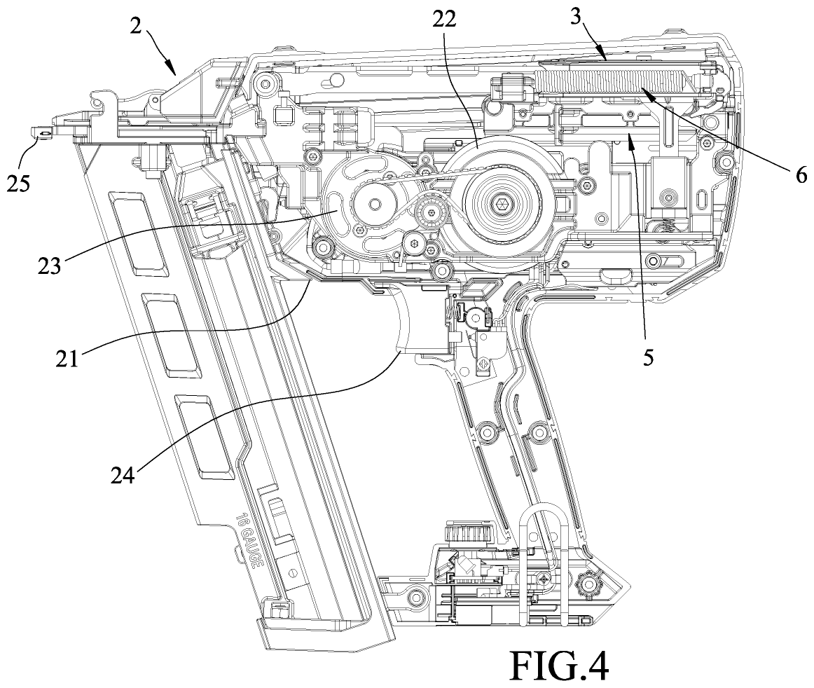

Referring to FIGS. 4, 5 and 6, an embodiment of a an impact device according to the disclosure is adapted to be mounted to an electric nail gun 2. The electric nail gun 2 includes a supporting frame 21, a flywheel 22, a motor unit 23, a trigger unit 24 and a safety unit 25. The flywheel 22 is rotatably mounted to the supporting frame 21. The motor unit 23 drives rotation of the flywheel 22. The trigger unit 24 is movably mounted to the supporting frame 21, is manually operable, and cooperates with the safety unit 25 to determine actuation of the motor unit 23 and whether to allow for a nail-striking operation.

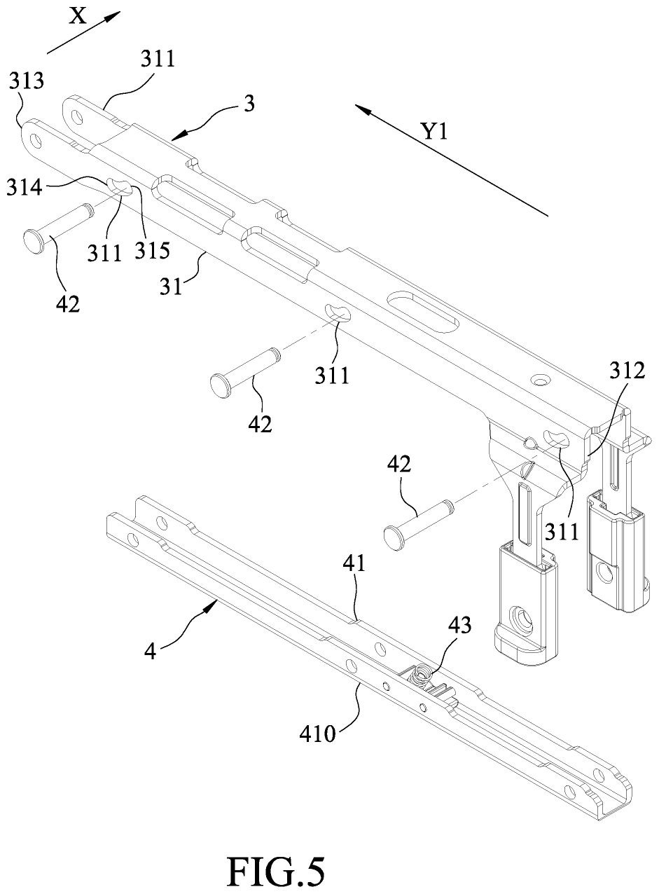

Referring to FIGS. 5, 6 and 7, the impact device includes a swing arm unit 3, a track unit 4, an impact unit 5 and two return units 6 (only one is shown).

The swing arm unit 3 extends in a striking direction (Y1), is adapted to be connected to the supporting frame 21, and is adapted to be pivotable relative to the supporting frame 21 toward or away from the flywheel 22. The swing arm unit 3 includes two side walls 31 that extend in the striking direction (Y1), and that are spaced apart in a connecting direction (X) perpendicular to the striking direction (Y1).

Each of the side walls 31 has a rear arm end 312 and a front arm end 313, and is formed with three track slots 311. The front arm end 313 of each of the side walls 31 is opposite to the rear arm end 312 of the same in the striking direction (Y1), and is adapted to be pivotally connected to the supporting frame 21.

The track slots 311 of each of the side walls 31 are arranged in the striking direction (Y1), and the track slots 311 of one of the side walls 31 are disposed respectively opposite to the track slots 311 of the other one of the side walls 31 in the connecting direction (X). Each of the track slots 311 is arc-shaped, and has a front end 314 and a rear end 315 that are substantially opposite to each other in the striking direction (Y1). The front end 314 and the rear end 315 of each of the track slots 311 are respectively proximate to the front arm end 313 and the rear arm end 312 of the corresponding one of the side walls 31.

The track unit 4 includes a guiding track 41, three bolt fasteners 42 and a resilient member 43.

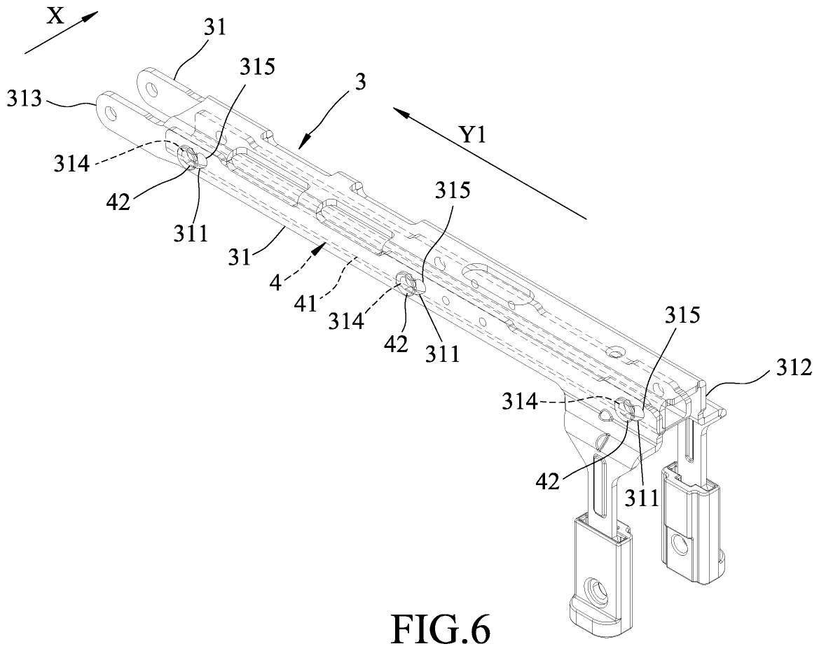

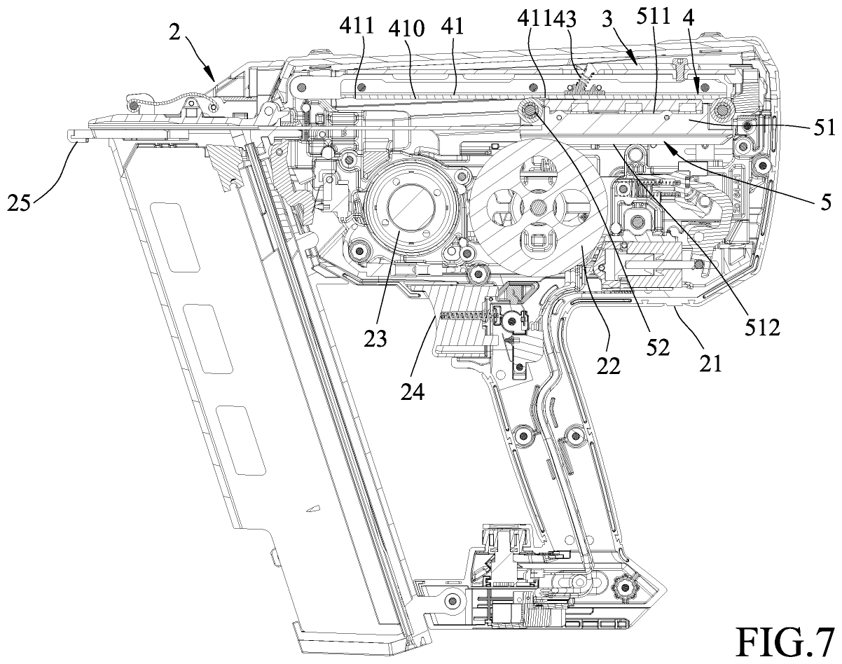

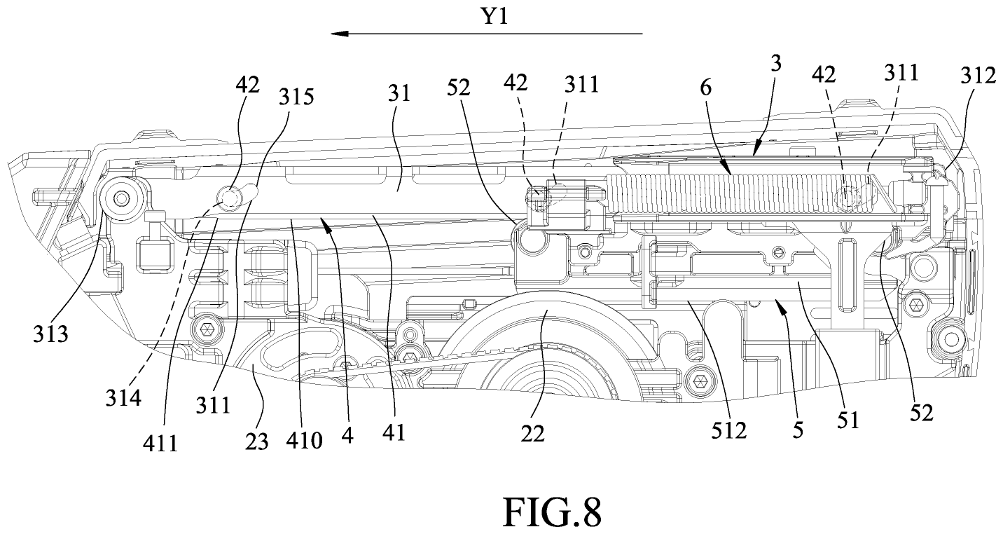

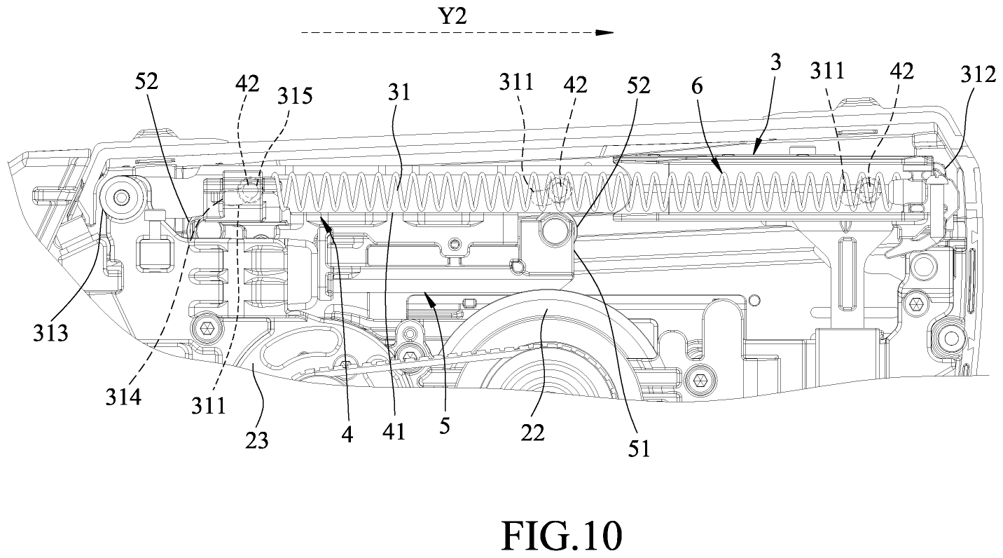

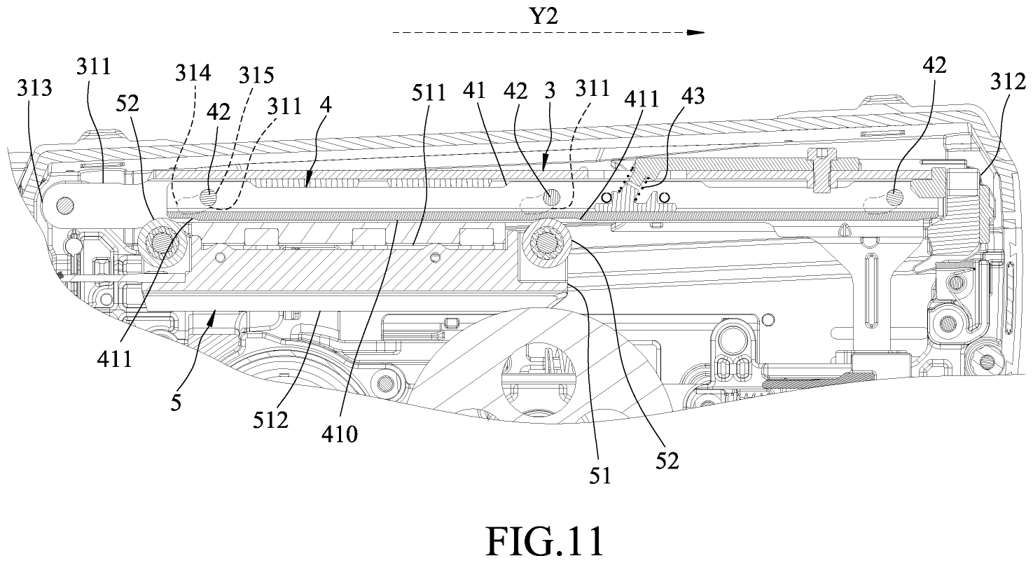

The guiding track 41 extends in the striking direction (Y1), is adapted to be disposed between the swing arm unit 3 and the flywheel 22, is movably connected to the swing arm unit 3, and has a rolling surface 410 that is adapted to face the flywheel 22, and that is formed with two arc-shaped grooves 411 (see FIGS. 7, 8 and 11). The arc-shaped grooves 411 are spaced apart from each other, and are respectively proximate to the rear arm end 312 and the front arm end 313 of each of the side walls 31. The guiding track 41 is movable resiliently relative to the swing arm unit 3 between a front position (see FIGS. 6 and 8), where the guiding track 41 is proximate to the flywheel 22, and a rear position (see FIGS. 10 and 11), where the guiding track 41 is distal from the flywheel 22.

Each of the bolt fasteners 42 passes through the guiding track 41 and extends through two corresponding ones of the track slots 311 that are opposite to each other in the connecting direction (X), such that the guiding track 41 is connected to the swing arm unit 3. When the guiding track 41 is at the front position, each of the bolt fasteners 42 is disposed in the front end 314 of each of the corresponding ones of the track slots 311. When the guiding track 41 is at the rear position, each of the bolt fasteners 42 is disposed in the rear end 315 of each of the corresponding ones of the track slots 311.

The resilient member 43 is disposed between the guiding track 41 and the swing arm unit 3 for biasing the guiding track 41 towards the front position.

The impact unit 5 is adapted to be disposed between the flywheel 22 and the guiding track 41, is movably connected to the guiding track 41, and includes an impact member 51 and two rollers 52.

The impact member 51 has a guiding surface 511 and a contact surface 512. The guiding surface 511 extends in the striking direction (Y1) and faces the guiding track 41. The contact surface 512 is opposite to the guiding surface 511, and is adapted to contact the flywheel 22 when the swing arm unit 3 is proximate to the flywheel 22. The rollers 52 are rotatably connected to the guiding surface 511 of the impact member 51, are proximate respectively to opposite ends of the guiding surface 511, and are in rolling contact with the rolling surface 410 of the guiding track 41.

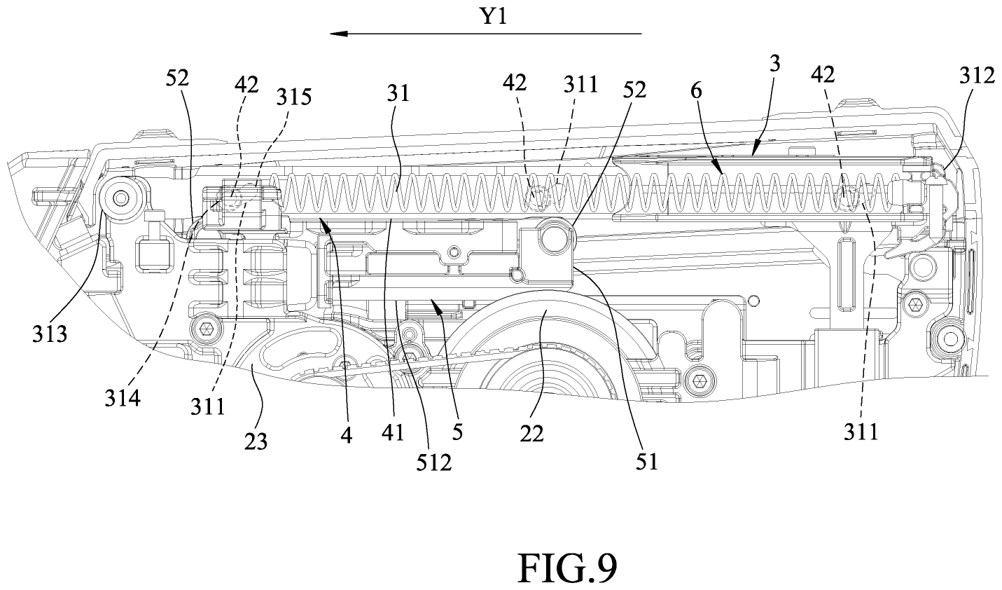

The impact unit 5 is movable relative to the guiding track 41 in the striking direction (Y1) and a return direction (Y2) that is opposite to the striking direction (Y1) between a pre-firing position (see FIGS. 7 and 8) and a firing position (see FIGS. 9 and 10).

When at the pre-firing position, the impact unit 5 is proximate to the rear arm end 312 of each of the side walls 31 of the swing arm unit 3. When at the firing position, the impact unit 5 is proximate to the front arm end 313 of each of the side walls 31 of the swing arm unit 3, and at least a portion of each of the rollers 52 is received in a respective one of the arc-shaped grooves 411 of the guiding track 41.

In addition, when the guiding track 41 is at the front position, the impact unit 5 is adapted to contact the flywheel 22 such that rotation of the flywheel 22 drives the impact unit 5 to move in the striking direction (Y1), and when the guiding track 41 is at the rear position, the impact unit 5 is adapted to be spaced apart from the flywheel 22 such that movement of the impact unit 5 in the return direction (Y2) is not affected by the flywheel 22.

Referring to FIG. 4, the return units 6 (only one is shown) are connected between the swing arm unit 3 and the impact unit 5 for biasing the impact unit 5 to move relative to the guiding track 41 in the return direction (Y2). It should be noted that the return units 6 are disposed respectively at opposite lateral sides of the swing arm unit 3 in a symmetrical manner.

Referring to FIGS. 4 and 7, when a user operates on the safety unit 25, the flywheel 22 starts rotating in the counterclockwise direction (in viewer's perspective). Once the flywheel 22 reaches a predetermined rotational speed (or a predetermined rotational energy), the user may operate on the trigger unit 24 to perform a single-nail-striking operation.

On the other hand, when the user operates first on the trigger unit 24 and then the safety unit 25, a consecutive-nail-striking operation may be performed; that is, the user may keep operating the safety unit 25 to strike multiple nails (not shown) without releasing the trigger unit 24.

As shown in FIGS. 8 and 9, when either of the above-mentioned nail-striking operations begins, a distance between the swing arm unit 3 and the flywheel 22 decreases, and the impact member 51 at the pre-firing position is driven to contact the flywheel 22 via the contact surface 512 thereof. Then, rotational energy of the flywheel 22 is released to the impact unit 5, and the rollers 52 of the impact unit 5 start moving along the guiding track 41 into the arc-shaped grooves 411, bringing the impact member 51 to move therewith in the striking direction (Y1) toward the front arm end 313 of the swing arm unit 3 (i.e., from the pre-firing position to the firing position). After striking the nail, as shown in FIGS. 4 and 10, the impact unit 5 is driven by the biasing force of the return units 6 to move in the return direction (Y2). During this time, the rollers 52 move along the guiding track 41, and the impact member 51 moves in the return direction (Y2) toward the rear arm end 312 of the swing arm unit 3 (i.e., from the firing position to the pre-firing position).

Referring to FIGS. 8 and 9, during the pivotal movement of the swing arm unit 3 that causes the impact member 51 to be driven by the flywheel 22 to move in the striking direction (Y1), the guiding track 41 is driven by the rollers 52 of the impact unit 5 to move in the striking direction (Y1) (with the bolt fasteners 42 moving along the track slots 311 of the swing arm unit 3), toward the pre-firing position. As such, the impact unit 5 remains in contact with the flywheel 22 until the nail is struck thereby.

Referring to FIGS. 10 and 11, during the process of the impact unit 5 being driven by the return units 6 to move in the return direction (Y2), the rollers 52, while rolling out of the arc-shaped grooves 411, exert forces onto the guiding track 41 and cause the guiding track 41 to overcome the biasing force of the resilient member 43 to move in the return direction (Y2), away from the flywheel 22, to the rear position (with the bolt fasteners 42 moving along the track slots 311 of the swing arm unit 3). In such a manner, the impact member 51 of the impact unit 5 becomes detached from the flywheel 22 and moves in the return direction (Y2) from the firing position back to the pre-firing position. It should be noted that the impact member 51 will not contact the flywheel 22 again during such movement. At the same time, the swing arm unit 3 is released and the distance between the swing arm unit 3 and the flywheel 22 is increased.

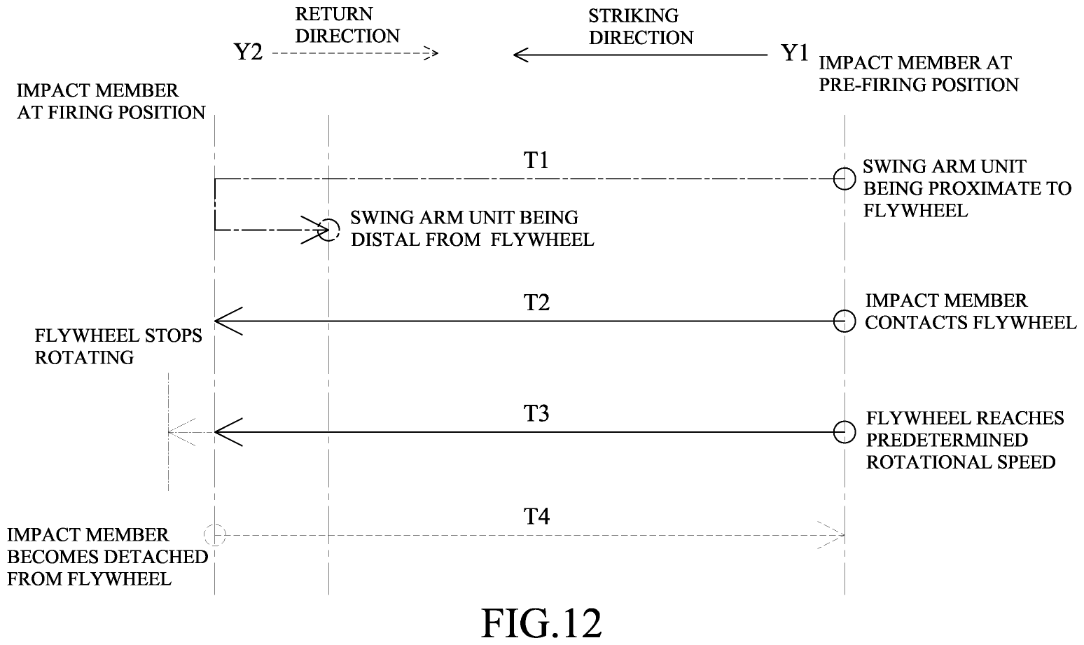

Referring to FIG. 4 and FIGS. 7 to 12, the following paragraphs describe four significant time periods that can be observed after the flywheel 22 starts rotating in the counterclockwise direction and reaches the predetermined rotational speed: a swinging time period (T1), a nail-striking time period (T2) and a moment of inertia time period (T3).

The swinging time period (T1) starts when the rear arm end 312 of the swing arm unit 3 is pivoted toward and most proximate to the flywheel 22 (i.e., the distance between the swing arm unit 3 and the flywheel 22 is decreased), and terminates when the rear arm end 312 is pivoted away from the flywheel 22 (i.e., the distance between the swing arm unit 3 and the flywheel 22 starts increasing). It should be noted that, during this time period, the impact unit 5 is brought into contact with the flywheel 22 and is driven by the rotational energy thereof to start moving in the striking direction (Y1) from the pre-firing position.

The nail-striking time period (T2) starts when the impact unit 5 is at the pre-firing position and when the impact unit 5 contacts the flywheel 22 that is rotating, and terminates when the impact unit 5 arrives at the firing position.

The moment of inertia time period (T3) starts when the impact unit 5 is at the pre-firing position and when the impact unit 5 contacts the flywheel 22 that is rotating (same as the nail-striking time period (T2)), and terminates when the flywheel 22 stops rotating. As such, the moment of inertia time period (T3) is longer than or equal to the nail-striking time period (T2).

In addition, another significant time period can be observed once the impact unit 5 starts moving in the return direction (Y2): a return time period (T4). The return time period (T4) starts when the impact unit 5 moves away from the firing position, and terminates when the impact unit 5 returns to the pre-firing position.

In order to ensure that the nail reaches a desired depth after each nail-striking operation, the electric nail gun 2 is designed in such manner that the swinging time period (T1) is longer than the nail-striking time period (T2), and that the moment of inertia time period (T3) is longer than or equal to the nail-striking time period (T2).

Since the impact unit 5 is detached from the flywheel 22 during its movement in the return direction (Y2), the movement of the impact unit 5 and the rotation of the flywheel 22 will not interfere with each other when a beginning portion of the return time period (T4) overlaps with an end portion of the swinging time period (T1). Therefore, whether the moment of inertia time period (T3) is longer than or equal to the nail-striking time period (T2), the flywheel 22 will never be forced to reverse its rotation (i.e., to rotate clockwise). As such, the flywheel 22 will either continuously rotate in the counterclockwise direction or stop rotating.

In view of the above, when the present embodiment is in the consecutive-nail-striking operation (where the flywheel 22 keeps rotating as long as the trigger unit 24 is being operated on), since the flywheel 22 is not interfered by the impact unit 5, less energy is wasted in driving the rotation of the flywheel 22, and the motor unit 23 does not require as much input energy as that of the prior art (i.e., the motor unit 23 will have a lower maximum voltage value in comparison with that of the prior art). In other words, the present embodiment is more energy efficient, and the motor unit 23 is prevented from being overheated.

In sum, the present embodiment of the impact device according to the disclosure has advantages as follows. By virtue of the configuration of the track unit 4, the impact unit 5 is allowed to be detached from the flywheel 22 during its movement in the return direction (Y2), which prevents the movement of the impact member 51 and the rotation of the flywheel 22 from interfering with each other, thereby increasing efficiency of the nail-striking operation and service life of the motor unit 23.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An impact device adapted to be mounted to an electric nail gun, the electric nail gun including a supporting frame, and a flywheel that is rotatably mounted to the supporting frame, said impact device comprising:
a swing arm unit adapted to be connected to the supporting frame, and adapted to be pivotable relative to the supporting frame toward or away from the flywheel;
a track unit including a guiding track that is movably connected to said swing arm unit; and
an impact unit adapted to be disposed between the flywheel and said guiding track, movably connected to said guiding track, and being movable relative to said guiding track in a striking direction and a return direction that are opposite to each other;
wherein said guiding track is movable resiliently relative to said swing arm unit between
a front position, where said impact unit is adapted to contact the flywheel such that rotation of the flywheel drives said impact unit to move in the striking direction, and
a rear position, where said impact unit is adapted to be spaced apart from the flywheel such that movement of said impact unit in the return direction is not affected by the flywheel.

2. The impact device as claimed in claim 1, wherein:
said swing arm unit has a plurality of track slots, each of which has a front end and a rear end that are substantially opposite to each other in the striking direction;
said track unit further includes a plurality of bolt fasteners, each of which passes through at least a corresponding one of said track slots and said guiding track; and
when said guiding track is at the front position, each of said bolt fasteners is disposed in said front end of said at least a corresponding one of said track slots, and when said guiding track is at the rear position, each of said bolt fasteners is disposed in said rear end of said at least a corresponding one of said track slots.

3. The impact device as claimed in claim 2, wherein said track unit further includes a resilient member disposed between said guiding track and said swing arm unit for biasing said guiding track towards the front position, each of said track slots being arc-shaped.

4. The impact device as claimed in claim 2, wherein said swing arm unit includes two side walls extending in the striking direction, being spaced apart in a connecting direction that is transverse to the striking direction, and formed with said track slots.

5. The impact device as claimed in claim 4, wherein:
said track slots includes six track slots, three of said track slots formed in one of said side walls and arranged in the striking direction, the other three of said track slots being formed in the other one of said side walls, being opposite to said three of said track slots in the connecting direction, and being arranged in the striking direction; and
said bolt fasteners includes three bolt fasteners, each of said bolt fasteners extending through two corresponding ones of said track slots that are opposite to each other in the connecting direction.

6. The impact device as claimed in claim 4, wherein each of said side walls of said swing arm unit has a rear arm end, and a front arm end that is opposite to said rear arm end in the striking direction and that is adapted to be pivotally connected to the machine frame, said impact unit being movable relative to said guiding track between a pre-firing position, where said impact unit is proximate to said rear arm end of each of said side walls, and a firing position, where said impact unit is proximate to said front arm end of each of said side walls.

7. The impact device as claimed in claim 6, wherein a nail-striking time period starts when said impact unit is at the pre-firing position and when said impact unit contacts the flywheel that is rotating, and terminates when said impact unit arrives at the firing position, and a moment of inertia time period starts when said impact unit is at the pre-firing position and when said impact unit contacts the flywheel that is rotating, and terminates when the flywheel stops rotating, said moment of inertia time period being longer than or equal to said nail-striking time period.

8. The impact device as claimed in claim 7, wherein a return time period starts when said impact unit moves away from the firing position, and terminates when said impact unit returns to the pre-firing position.

9. The impact device as claimed in claim 1, further comprising at least one return unit connected between said swing arm unit and said impact unit for biasing said impact unit to move relative to said guiding track in the return direction.

10. The impact device as claimed in claim 1, wherein:
said swing arm unit has at least one rear arm end, and at least one front arm end that is opposite to said at least one rear arm end in the striking direction and that is adapted to be pivotally to the supporting frame;
said guiding track has a rolling surface that is adapted to face the flywheel, and that is formed with two arc-shaped grooves, said arc-shaped grooves being spaced apart from each other, and being respectively proximate to said at least one rear arm end and said at least one front arm end;
said impact unit includes an impact member that is adapted to contact the flywheel when said swing arm unit is proximate to the flywheel, and two rollers that are rotatably connected to said impact member, and that are in rolling contact with said rolling surface of said guiding track; and
said impact unit is movable relative to said guiding track between a pre-firing position, where said impact unit is proximate to said at least one rear arm end of said swing arm unit, and a firing position, where said impact unit is proximate to said at least one front arm end of said swing arm unit, and where at least a portion of each of said rollers is received in a respective one of said arc-shaped grooves of said guiding track.
